(19) United States
(12) Patent Application Publication
(10) Pub. No.: US 2020/0343573 A1
(43) Pub. Date: Oct. 29, 2020

(54) ASSEMBLY CONSISTING OF A STACK WITH SOLID OXIDES OF THE SOEC/SOFC TYPE AND OF A CLAMPING SYSTEM INTEGRATING A HEAT EXCHANGE SYSTEM

(71) Applicant: COMMISSARIAT À L'ÉNERGIE ATOMIQUE ET AUX ÉNERGIES ALTERNATIVES, Paris (FR)

(72) Inventors: Guilhem Roux, Saint-Egreve (FR); Charlotte Bernard, Contamine Sur Arve (FR); Michel Planque, Seyssins (FR)

(21) Appl. No.: 16/757,000

(22) PCT Filed: Oct. 23, 2018
(86) PCT No.: PCT/FR2018/052629

§ 371 Date: Apr. 17, 2020

(30) Foreign Application Priority Data
Oct. 26, 2017 (FR) 1760106

(51) Int. Cl. H01M 8/2432; H01M 8/0271; H01M 8/04014; H01M 8/04029; H01M 8/04007; H01M 8/248; C25B 1/08; C25B 1/10; C25B 9/20

(52) U.S. Cl. CPC H01M 8/2432; H01M 8/0271; H01M 8/04014; H01M 8/04029; H01M 2008/1293; H01M 8/248; C25B 1/08; C25B 1/10; C25B 9/206; H01M 8/04074

(57) ABSTRACT

An assembly comprising a SOEC/SOFC-type solid oxide stack, and a clamping system for the stack, said clamping system comprising at least two clamping rods that can be used to assemble upper and lower clamping plates. The assembly further comprises a heat exchange system formed at least in part by at least two hollow clamping rods of the clamping system, through which a fluid to be superheated or preheated flows.

### TECHNICAL FIELD

The present invention relates to the general field of High Temperature Electrolysis (HTE), in particular High Temperature Steam Electrolysis (HTSE), the electrolysis of carbon dioxide (CO₂), or even also the coelectrolysis of High Temperature Electrolysis (HTE) with carbon dioxide (CO₂).

More precisely, the invention relates to the field of high temperature Solid Oxide Electrolyzer Cells (SOEC).

It also relates to the field of high temperature Solid Oxide Fuel Cells (SOFC).

Thus, more generally, the invention refers to the field of solid-oxide stacks of the SOEC/SOFC type functioning at high temperature.

More precisely, the invention relates to an assembly comprising a solid-oxide stack of the SOEC/SOFC type and a system for clamping the stack with an integrated heat exchange system, as well as a method for manufacturing such a heat exchange system.

### PRIOR ART

In the context of a high temperature solid oxide electrolyzer of the SOEC type, it is a case of transforming, by means of an electric current, within the same electrochemical device, steam (H₂O) into dihydrogen (H₂) and dioxygen (O₂), and/or also transforming carbon dioxide (CO₂) into carbon monoxide (CO) and dioxygen (O₂). In the context of a high temperature solid-oxide fuel cell of the SOFC type, the functioning is the reverse in order to produce an electric current and heat by being supplied with dihydrogen (H₂) and dioxygen (O₂), typically with air and natural gas, namely by means of methane (CH₄). For reasons of simplicity, the following description relates mostly to the functioning of a high temperature solid-oxide electrolyzer of the SOEC type carrying out the electrolysis of water. However, this functioning is applicable to the electrolysis of carbon dioxide (CO₂), or even to the coelectrolysis of High Temperature Electrolysis (HTE) with carbon dioxide (CO₂). In addition, this functioning can be transposed to the case of a high temperature solid oxide fuel cell of the SOFC type.

In order to carry out electrolysis of water, it is advantageous to carry it out at high temperature, typically between 600° and 1000° C., since it is more advantageous to electrolyze steam than liquid water and because some of the energy necessary for the reaction can be provided by heat, which is less expensive than electricity.

In order to implement High Temperature Electrolysis (HTE), a high temperature solid oxide electrolyzer of the SOEC type consists of a stack of elementary patterns each comprising a solid oxide electrolysis cell, or electrochemical cell, consisting of three anode/electrolyte/cathode layers placed one above the other, and interconnection plates made from metal alloys, also referred to bipole plates or interconnectors. Each electrochemical cell is gripped between two interconnection plates. A high temperature solid oxide electrolyzer of the SOEC type is then an alternating stack of electrochemical cells and interconnectors. A high temperature solid oxide fuel cell of the SOFC type consists of the same type of stack of elementary patterns. This high temperature technology being reversible, the same stack can function in electrolysis mode and produce hydrogen and oxygen from water and electricity, or in fuel cell mode and product electricity from hydrogen and oxygen.

Each electrochemical cell corresponds to an electrolyte/electrode assembly, which is typically a multilayer ceramic assembly the electrolyte of which is formed by a central ion-conducting layer, this layer being solid, dense and impervious, and gripped between the two porous layers forming the electrodes. It should be noted that supplementary layers may exist, but which serve only to improve one or more of the layers already described.

The interconnection devices, electrical and fluidic, are electron conductors that, from an electrical point of view, provide the connection of each elementary-pattern electrochemical cell in the stack of elementary patterns, guaranteeing electrical contact between a face and the cathode of one cell and between the other face and the anode of the following cell, and, from a fluidic point of view, thus combining the production of each of the cells. The interconnectors thus fulfil the functions of bringing and collecting electric current and delimiting gas-circulation compartments, for distribution and/or collection.

More precisely, the main function of the interconnectors is to provide the passage of the electric current but also the circulation of the gases in the vicinity of each cell (namely: injecting steam, hydrogen and oxygen extracted for the (HTE) electrolysis; air and fuel, including the injected hydrogen and water extracted for a SOFC cell), and separating the anode and cathode compartments of two adjacent cells, which are the compartments for circulation of gases alongside respectively the anodes and cathodes of the cells.

In particular, for a high temperature solid oxide electrolyzer of the SOEC type, the cathodic compartment comprises steam and hydrogen, the product of the electrochemical reaction, while the anodic compartment comprises a purge gas, if present, and oxygen, the other product of the electrochemical reaction. For a high temperature solid oxide fuel cell of the SOFC type, the anodic compartment comprises fuel, while the cathodic compartment comprises the oxidant.

In order to carry out High Temperature Steam Electrolysis (HTSE), steam (H₂O) is injected into the cathodic compartment. Under the effect of the electric current applied to the cell, the dissociation of the water molecules in the form of steam is effected at the interface between the hydrogen electrode (the cathode) and the electrolyte; this dissociation produces dihydrogen gas (H₂) and oxygen ions (O²⁻). The dihydrogen (H₂) is collected and discharged at the outlet of the hydrogen compartment. The oxygen ions (O²⁻) migrate through the electrolyte and recombine as dioxygen (O₂) at the interface between the electrolyte and the oxygen electrode (anode). A purge gas, such as air, can circulate at the anode and thus collect the oxygen generated in gaseous form at the anode.

In order to provide the functioning of a solid oxide fuel cell (SOFC), air (oxygen) is injected into the cathodic compartment of the cell and hydrogen into the anodic compartment. The oxygen from the air will dissociate into O²⁻ ions. These ions will migrate in the electrolyte from the cathode to the anode in order to oxidize the hydrogen and form water with the simultaneous production of electricity. In an SOFC cell, just as in SOEC electrolysis, the steam is situated in the dihydrogen (H₂) compartment. Only the polarity is reversed.

By way of illustration, FIG. 1 depicts a schematic view showing the operating principle of a high temperature solid oxide electrolyzer of the SOEC type. The function of such an electrolyzer is to transform the steam into hydrogen and oxygen in accordance with the following electrochemical reaction:

2H₂O→2H₂+O₂.

This reaction is achieved electrochemically in the cells of the electrolyzer. As shown schematically in FIG. 1, each elementary electrolysis cell 1 is formed by a cathode 2 and an anode 4, placed on either side of a solid electrolyte 3. The two electrodes (cathode and anode) 2 and 4 are electron and/or ion conductors, made from porous material, and the electrolyte 3 is gastight, insulating with regard to electrons and conductive of ions. The electrolyte 3 may in particular be an anionic conductor, more precisely an anionic conductor of O²⁻ ions, and the electrolyzer is then termed an anionic electrolyzer, in contradistinction to protonic electrolytes (H⁺).

The electrochemical reactions take place at the interface between each of the electron conductors and the ion conductor.

At the cathode 2, the semireaction is as follows:

2H₂O+4e⁻→2H₂+2O²⁻.

At the anode 4, the semireaction is as follows:

2O²⁻→O₂+4e⁻.

The electrolyte 3, interposed between the two electrodes 2 and 4, is the migration site of the O²⁻ ions under the effect of the electrical field created by the difference in potential imposed between the anode 4 and the cathode 2.

As illustrated between parentheses in FIG. 1, the steam entering the cathode may be accompanied by hydrogen H₂, and the hydrogen produced and recovered at the outlet may be accompanied by steam. Likewise, as illustrated in broken lines, a purge gas, such as air, may also be injected at the inlet in order to discharge the oxygen produced. The injection of a purge gas has the additional function of fulfilling the role of heat regulator.

An elementary electrolyzer, or electrolysis reactor, consists of an elementary cell as described above, with a cathode 2, an electrolyte 3 and an anode 4, and two interconnectors that fulfill the functions of electrical, hydraulic and thermal distribution.

In order to increase the flows of hydrogen and oxygen produced, stacking a plurality of elementary electrolysis cells on top of one another whilst separating them by interconnectors is known. The assembly is positioned between two end interconnection plates that support the electrical supplies and gas supplies to the electrolyzer (electrolysis reactor).

A high temperature solid oxide electrolyzer of the SOEC type thus comprises at least one, and generally a plurality of electrolysis cells stacked one on top of the other, each elementary cell being formed by an electrolyte, a cathode and an anode, the electrolyte being interposed between the anode and the cathode.

As indicated previously, the fluidic and electrical interconnection devices that are in electrical contact with one or more electrodes in general fulfil the functions of bringing and collecting electric current and delimit one or more gas-circulation compartments.

Thus the function of the so-called cathodic compartment is the distribution of electric current and steam as well as the recovery of hydrogen at the cathode in contact.

The function of the so-called anodic compartment is the distribution of the electric current as well as the recovery of the oxygen produced at the anode in contact, optionally by means of a purge gas.

FIG. 2 shows an exploded view of elementary patterns of a high temperature solid oxide electrolyzer of the SOEC type according to the prior art. This electrolyzer comprises a plurality of elementary electrolysis cells C1, C2, of the solid oxide (SOEC) type, stacked in alternation with interconnectors 5. Each cell C1, C2 consists of a cathode 2.1, 2.2 and an anode (only the anode 4.2 of the cell C2 is depicted), between which an electrolyte is disposed (only the electrolyte 3.2 of the cell C2 is depicted).

The interconnector 5 is a metal-alloy component that provides the separation between the cathodic 50 and anodic 51 compartments, defined by the volumes lying between the interconnector 5 and the adjacent cathode 2.1 and between the interconnector 5 and the adjacent anode 4.2 respectively. It also provides the distribution of the gases to the cells. The injection of steam in each elementary pattern is done in the cathodic compartment 50. The collection of the hydrogen produced and of the residue of steam at the cathode 2.1, 2.2 is effected in the cathodic compartment 50 downstream of the cell C1, C2 after dissociation of the steam by it. The collection of the oxygen produced at the anode 4.2 is effected in the anodic compartment 51 downstream of the cell C1, C2 after dissociation of the steam by it. The interconnector 5 provides the passage of the current between the cells C1 and C2 by direct contact with the adjacent electrodes, that is to say between the anode 4.2 and the cathode 2.1.

The operating conditions of a high temperature solid oxide electrolyzer (SOEC) being very similar to those of a solid oxide fuel cell (SOFC), the same technological constraints are found.

Thus the correct functioning of such solid-oxide stacks of the SOEC/SOFC type functioning at high temperature mainly require to satisfy the points stated below.

First of all, it is necessary to have electrical isolation between two successive interconnectors otherwise the electrochemical cell would be short-circuited, but also good electrical contact and a sufficient contact surface between a cell and an interconnector. The lowest possible ohmic resistance is sought between cells and interconnectors.

Moreover, it is necessary to have impermeability between the anodic and cathodic compartments otherwise there would be a recombination of the gases produced, causing a reduction in yield and especially the appearance of hot spots damaging the stack.

Finally, it is essential to have good distribution of the gases both at the inlet and at the recovery of the products otherwise there would be a loss of yield, unevenness of pressure and temperature in the various elementary patterns, or even unacceptable degradation of the electrochemical cells.

The incoming and outgoing gases in a high temperature electrolysis stack (SOEC) or fuel cell (SOFC) functioning at high temperature can be managed by means of suitable devices such as a furnace as illustrated with reference to FIG. 3.

The furnace 10 thus comprises cold parts PF and hot parts PC, the latter comprising the floor of the furnace 11, a loop tube 12 for managing the inlets and outlets of gas, and the high temperature electrolysis (SOEC) or fuel cell (SOFC) stack 20.

Conventionally, there exist two main techniques for implementing the superheating of the inlet gases in a high temperature electrolysis stack (SOEC) or fuel cell (SOFC).

First of all, as depicted schematically by the loop tube 12 in FIG. 3, it is possible to use lengths of tube coiled in line with the heating elements of a furnace 10 in the hot part PC. The gases will previously have been raised to a temperature of approximately 500° C. at the outlet from heat exchangers if this is provided for by the system. Then this or these tubes 12 for superheating the gases make it possible to gain approximately 300° C. in addition by using the thermal radiation of the heating elements of the furnace 10 and stack 20, before being introduced into the stack 20.

Moreover, passing the gases through electric heaters 30 such as the one depicted in FIG. 4 is also known. Such an electric heater 30 is similar to a solid assembly comprising a steel inertial mass 31, a heating element 32 and a tube 33 for conducting the gases coiled on the inertial mass 31. FIG. 4 also shows incoming gases GE and outgoing gases GS. These electric heaters 30 are responsible for heating the incoming gases GE at 20° C. to a temperature of approximately 800° C. before introducing the outgoing gases GS into the stack 20.

The correct functioning of the system in both cases requires a very precise temperature at the input to the stack 20 in order to guarantee correct functioning of the assembly.

The first technique which, after the gases pass through the heat exchangers, recovers the radiation from the heating elements of the furnace in order to raise the gases to the correct stack inlet temperature, therefore makes it necessary to make coils with a length of approximately 3 m (the example given for a stack of 25 cells with an active surface area of 10 cm×10 cm), which gives rise to the drawback of adding complexity in the bends to ensure that the tubes arrive at the correct places in a confined space, and which significantly increases the size of the furnace. Implementation is therefore complicated since it is necessary to be precise and since tubes, typically with a diameter of 10/12 made from 316L stainless steel or Inconel 600, are very rigid. Moreover, making gas superheating loops takes up a great deal of space, and necessarily interferes with the current feeds, the passage for thermocouples and the outlet tubes of the electrolyzer, which often leads to shortening these lines because of the lack of space in the furnace. In addition, it is necessary to carry out the same bending work again at each new stack, since dismantling the connection of these loops is destructive.

As a general rule, in order to obtain the correct temperature and the inlet to the stack 20, and for an inside diameter of tubes 12 of approximately 10 mm, a developed length of approximately 3 m is necessary per inlet gas line, typically H₂O and N₂O₂, with a flowrate of between 5 and 15 Nm³/s. This length of approximately 3 m, which makes it possible to achieve the regulation temperature of the furnace as an output, functions both in high temperature electrolysis stack (SOEC) mode or the fuel cell (SOFC) mode, and guarantees the correct temperature at the entry to the stack.

Furthermore, it is necessary to carry out an expensive and lengthy treatment of these gas lines by the deposition of alumina in order to avoid pollution due to phenomena of oxidation when 316L stainless steel is used. The particles entrained by the gas flow (chromium, vanadium, etc.) may be fixed to this cell, and thus reduce the performances of the solid-oxide stack of the SOEC/SOFC type.

Moreover, the second technique requires one superheater 30 per gas inlet. However, these are massive assemblies that take up a great deal of space whereas the trend is more towards compact systems. There are therefore as many electric superheaters as there are gas inlets, which, in the context of the integration of peripheral elements in a furnace, poses serious problems. There is therefore a need to place the gas outlet of this electric heater 30 as close as possible to the stack inlets in order to avoid tracing of the line by heating arm.

### DISCLOSURE OF THE INVENTION

The aim of the invention is to at least partially remedy these requirements mentioned above and the drawbacks relating to the embodiments of the prior art.

It relates in particular to the implementation of a design of an integrated assembly or a stack and heat-exchange system, in particular for superheating or preheating gas, for a high temperature electrolysis stack (SOEC) or fuel cell (SOFC), while limiting, or even eliminating, the need for external parts. This system must therefore be able to be integrated in the stack having a character of the Plug and Play (PnP) type, self-clamping system), as described in the French patent application FR 3 045 215 A1.

The object of the invention, according to one of the aspects thereof, is thus an assembly comprising:
a solid-oxide stack of the SOEC/SOFC type functioning at high temperature, comprising:
   a plurality of electrochemical cells each formed by a cathode, an anode and an electrolyte interposed between the cathode and the anode, and a plurality of intermediate interconnectors each arranged between two adjacent electrochemical cells,
   a top end plate and a bottom end plate, between which the plurality of electrochemical cells and the plurality of intermediate interconnectors are gripped,
a system for gripping the solid-oxide stack of the SOEC/SOFC type, comprising a top clamping plate and a bottom clamping plate, between which the solid-oxide stack of the SOEC/SOFC type is gripped, each clamping plate comprising at least two clamping orifices, the clamping system further comprising:
   at least two clamping rods intended each to extend through a clamping orifice in the top clamping plate and through a corresponding clamping orifice in the bottom clamping plate to enable the top and bottom clamping plates to be assembled together,
   clamping means at each clamping orifice of the top and bottom clamping plates intended to cooperate with said at least two clamping rods in order to enable the top and bottom clamping plates to be assembled together, characterized in that it comprises a heat exchange system formed at least partly by at least two hollow clamping rods of the clamping system inside which a fluid to be superheated or preheated circulates.

Thus, advantageously, the invention can make it possible to use clamping rods by making them hollow in order to form heat exchangers for superheating or preheating one or more fluids. This fluid(s) may be liquid or gaseous, preferably being gaseous.

Thanks to the invention, it is possible to dispense with the complicated tubular coils to be used, as described previously in relation to the first gas superheating technique. There is therefore obtained a significant gain in terms of size. The invention enables the principle of superheating or preheating to be integrated in the clamping system without the addition of any external part, which makes it possible to limit the size of the furnace. The thermal efficiency can be increased by the use of swirl means.

In addition, since the heat exchange system forms part of the clamping system, it is possible to avoid remaking the tubular coils with each new stack whereas the system of tubular loops according to the first prior art is not recoverable. Advantageously, the heat exchange system can be used for other stacks.

The assembly according to the invention can further comprise one or more of the following features taken in isolation or in accordance with all possible technical combinations.

According to a first aspect of the invention, said at least two hollow clamping rods can each comprise an end for the entry of a heat-transfer fluid to be preheated and an end for exit of the preheated heat transfer fluid.

In addition, at each of the inlet and outlet ends of each clamping rod, the clamping system may comprise a force transmission tube, disposed around the corresponding end of the clamping rod, and clamping means, in particular a clamping washer, the force transmission tube being positioned between the clamping washer and the corresponding clamping plate. This makes it possible to be able to offset the clamping in a cold zone. In this case, this can fulfil only the role of preheating of the gases since it is necessary to leave and re-enter the furnace. It can also be envisaged using this circuit independently of the gases in order for example to use the exothermicity of the stack in SOFC mode to heat water by thermalizing the stack.

Furthermore, at each of the inlet and outlet ends of each clamping rod, the clamping system may comprise a thermal-insulation part, in particular made from ceramic, disposed around the corresponding end of the clamping rod, the thermal-insulation part being positioned in contact with the corresponding clamping plate.

Moreover, according to a second aspect of the invention, the heat exchange system may be a system for superheating the gases at the inlet of the solid-oxide stack of the SOEC/SOFC type, formed at least partly by at least two hollow clamping rods of the clamping system inside which the gases or liquids to be superheated circulate, the assembly comprising a pipe for entering the stack fluidically connected to at least one hollow clamping rod.

Advantageously, the superheating system is formed by at least one hollow clamping rod per fluid circuit.

In addition, the superheating system may be of so-called simple mounting, comprising a simple-mounting connection pipe fluidically connecting the inlet pipe and one end of a hollow clamping rod, the other end of the hollow clamping rod being fluidically connected to a pipe for supplying gas to be superheated.

The superheating system may also be of so-called mounting in series, comprising a set of pipes for mounting in series, comprising a first pipe for mounting-in-series connection, fluidically connecting a first end of a first hollow clamping rod to a first end of a second hollow clamping rod, and a second pipe for mounting-in-series connection fluidically connecting the second end of the first clamping rod to the pipe for entering the stack, the second end of the second hollow clamping rod being fluidically connected to a pipe for the entry of gas to be superheated.

The superheating system may also be of the so-called parallel mounting type, comprising a set of parallel-mounting pipes, comprising a first parallel-mounting connection pipe fluidically connecting a first end of a first hollow clamping rod to a first end of a second hollow clamping rod, and a second parallel-mounting connection pipe fluidically connecting the second end of the first clamping rod to the second end of the second hollow clamping rod, the second parallel-mounting connection pipe being fluidically connected to the pipe for entering the stack, in particular by means of a connection pipe itself fluidically connected to the pipe for entering the stack, the first parallel-mounting connection pipe being fluidically connected to a pipe for the entry of gas to be superheated.

Moreover, the hollow clamping rods may advantageously comprise swirl means, for increasing the heat exchange with the fluid to be superheated or preheated.

The presence of swirl means in the hollow clamping rods may make it possible to increase the efficacy of heat exchange. This is because the normal length of a clamping rod may prove to be insufficient to allow superheating or preheating of the fluid, which may for example correspond to a change from 50° C. to 800° C. for gases to be superheated.

The swirl means may be in the form of long twisted ribbons inserted in the hollow clamping rods, and have the advantage of being simple to fit. They make it possible to increase, for the same flow, the residence time of the fluid for a given length, while limiting the increase in pressure drop, which is particularly desirable.

Furthermore, the clamping system may comprise, at each end of a hollow clamping rod, clamping means, in particular a clamping washer, in contact with a clamping plate.

In addition, the fluid connections between fluid pipes and/or between fluid pipes and hollow clamping rods may be made by means of one or more demountable fluidtight couplings.

Advantageously, the ends of the clamping rods are threaded. It may therefore be possible to fix thereon demountable fluidtight couplings provided with a thread.

The demountable fluidtight coupling may in particular be formed by a coupling system fluidtight at high temperature, comprising:
a hollow base at least partially threaded on its external surface, referred to as a threaded base, intended to be fixed to a first fluid pipe or a hollow clamping rod, the threaded base comprising an orifice for putting in fluid communication with the first fluid pipe or the clamping rod,
a hollow base with an external surface at least partially smooth, referred to as a smooth base, intended to be fixed to a second fluid pipe or a hollow clamping rod, the smooth base comprising an orifice for putting in fluid communication with the second fluid pipe or the hollow clamping rod, the smooth base and the threaded base each comprising an orifice for putting them in fluid communication with one another,
a threaded nut, able to cooperate with the threaded base in order to form a screw/nut system and able to slide with respect to the smooth base, the threaded nut comprising, on the internal surface thereof, a first threaded portion cooperating with the thread on the threaded base and a second smooth portion in sliding contact on the smooth external surface of the smooth base.

Such a demountable fluidtight coupling is in particular as described in the French patent application no. 17 50009.

Preferentially, the useful cross-section of the hollow clamping rods is sufficient to withstand any creep at high temperature that may be caused by cold clamping of the stack.

Moreover, the object of the invention is also, according to another of the aspects thereof, a method for manufacturing at least one heat exchange system, in particular a system for superheating gas at the inlet of a solid oxide stack of the SOEC/SOFC type or a system for preheating a heat transfer fluid, of an assembly as defined previously, characterized that it comprises the step consisting of forming a plurality of hollow clamping rods and fluidically connecting one or more fluid pipes with the hollow clamping rods so as to allow circulation of a fluid inside the hollow clamping rods.

The assembly and manufacturing method according to the invention may comprise any of the features stated in the description, taken in isolation or in accordance with all technically possible combinations with other features.

### BRIEF DESCRIPTION OF THE DRAWINGS

The invention will be able to be understood better from a reading of the following detailed description of non-limitative examples of implementation thereof, as well as from an examination of the schematic and partial figures of the accompanying drawing, on which:

FIG. 1 is a schematic view showing the operating principle of a high temperature solid oxide electrolyzer (SOEC),

FIG. 2 is an exploded schematic view of part of a high temperature solid oxide electrolyzer (SOEC) comprising interconnectors according to the prior art,

FIG. 3 illustrates the principle of the architecture of a furnace on which a high temperature electrolysis stack (SOEC) or fuel cell (SOFC) functioning at high temperature is placed,

FIG. 4 illustrates the principle of an electrical gas heater according to the prior art,

FIG. 5 depicts, in perspective, an example of an assembly according to the invention comprising a solid oxide stack of the SOEC/SOFC type and a system for clamping the stack, which may comprise one or more of the heat exchange systems as depicted with reference to FIGS. 6 to 10,

FIGS. 6 to 10 illustrate partially, schematically and in cross-section, examples of heat exchange systems according to the invention that can be used in an assembly such as the one depicted in FIG. 5, and

FIG. 11 illustrates, partially in cross-section and in perspective, an example of a demountable fluidtight coupling in the form of a coupling system fluidtight at high temperature for an assembly according to the invention.

In all these figures, identical references can designate identical or similar elements.

In addition, the various parts depicted in the figures are not necessarily according to a uniform scale, in order to make the figures more legible.

### DETAILED DISCLOSURE OF PARTICULAR EMBODIMENTS

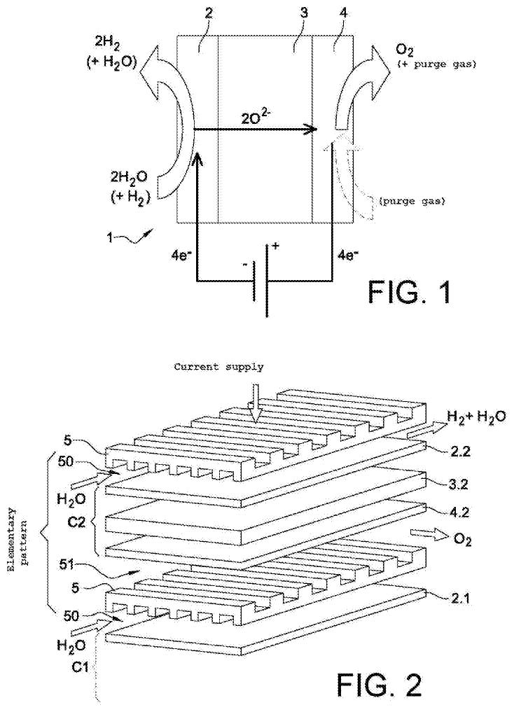

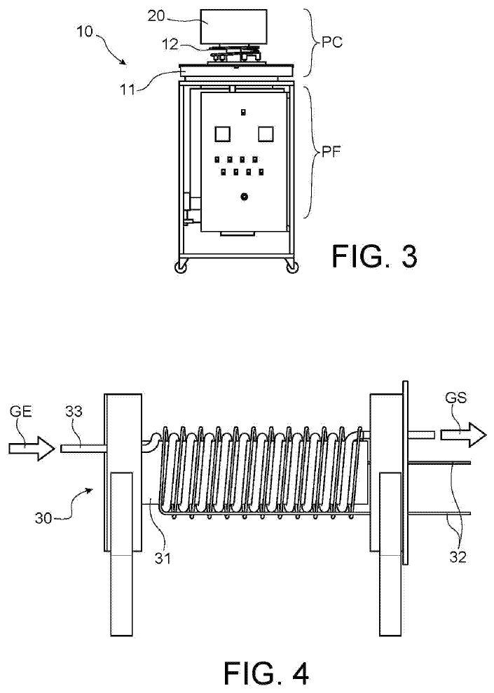

FIGS. 1 to 4 have already been described previously in the part relating to the prior art and to the technical context of the invention. It is stated that, for FIGS. 1 and 2, the symbols and the arrows for the supply of steam H₂O and the distribution and recovery of dihydrogen H₂, oxygen O₂, air and electric current, are shown for purposes of clarity and information, in order to illustrate the functioning of the devices depicted.

Furthermore, it should be noted that all the constituents (anode/electrode/cathode) of a given electrochemical cell are preferentially ceramics. The operating temperature of a stack of the high temperature SOEC/SOFC type is moreover typically between 600° and 1000° C.

In addition, any terms “top” and “bottom” are to be understood here according to the normal direction of orientation of a stack of the SOEC/SOFC type when in the configuration of use thereof.

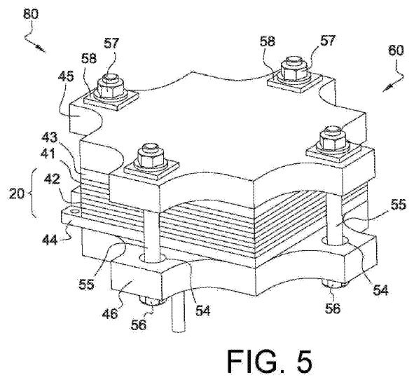

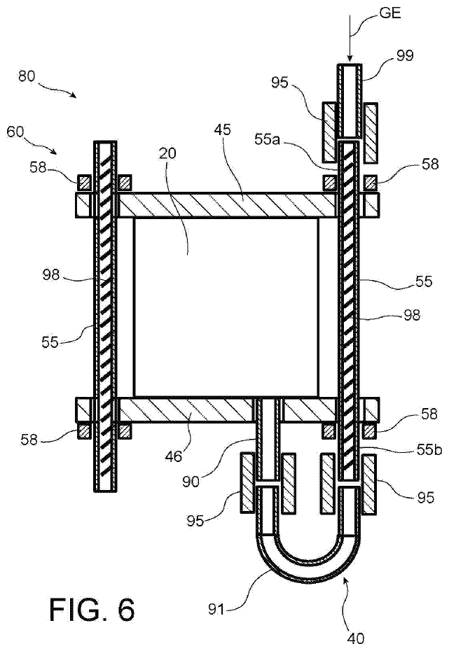

With reference to FIG. 5, this illustrates an example of an assembly 80 comprising a solid-oxide stack 20 of the SOEC/SOFC type and a clamping system 60, this assembly 80 being able to comprise one or more of the heat exchange systems 40 described hereinafter with reference to FIGS. 6 to 10.

Advantageously, the assembly 80 according to the invention has a structure similar to that of the assembly described in the French patent application FR 3 045 215 A1, apart from the presence here of a heat exchange system, that is to say this stack 20 has a character of the “Plug and Play” (PnP) type.

Thus, in a way that is common to the various embodiments of the invention described hereinafter, and as can be seen in FIG. 5, the assembly 80 comprises a solid-oxide stack 20 of the SOEC/SOFC type functioning at high temperature.

This stack 20 comprises a plurality of electrochemical cells 41 each formed by a cathode, an anode and an electrolyte interposed between the cathode and the anode, and a plurality of intermediate connectors 42 each arranged between two adjacent electrochemical cells 41. This assembly of electrochemical cells 41 and intermediate interconnectors 42 can also be designated a stack.

In addition, the stack 20 comprises a top end plate 43 and a bottom end plate 44, also respectively referred to as top stack end plate 43 and bottom stack end plate 44, between which the plurality of electrochemical cells 41 and the plurality of intermediate interconnectors 42 are gripped, that is to say between which the stack is situated.

Moreover, the assembly 80 also comprises a system 60 for clamping the solid-oxide stack 20 of the SOEC/SOFC type, comprising a top clamping plate 45 and a bottom clamping plate 46, between which the solid-oxide stack 20 of the SOEC/SOFC type is gripped.

Each clamping plate 45, 46 of the clamping system 60 comprises four clamping orifices 54.

In addition, the clamping system 60 further comprises four clamping rods 55, or tie rods, extending through a clamping orifice 54 of the top clamping plate 45 and through a corresponding clamping orifice 54 of the bottom clamping plate 46 to enable the top 45 and bottom 46 clamping plates to be assembled together.

The clamping system 60 also comprises clamping means 56, 57, 58 at each clamping orifice 54 of the top 45 and bottom 46 clamping plates cooperating with the clamping rods 55 to enable the top 45 and bottom 46 clamping plates to be assembled together.

More precisely, the clamping means comprise, at each clamping orifice 54 of the top clamping plate 45, a first clamping nut 56 cooperating with the corresponding clamping rod 55 inserted through the clamping orifice 54. In addition, the clamping means comprise, at each clamping orifice 54 of the bottom clamping plate 46, a second clamping nut 57 associated with a clamping washer 58, these cooperating with the corresponding clamping rod 55 inserted through the clamping orifice 54. The clamping washer 58 is situated between the second clamping nut 57 and the bottom clamping plate 46.

In accordance with the invention, the assembly 80 comprises at least one heat exchange system 40, for example such as the ones described with reference to FIGS. 6 to 10 but not visible in FIG. 5, formed at least partly by a hollow clamping rod 55 of the clamping system 60 inside which a fluid to be superheated or preheated circulates.

Thus various possibilities of a heat exchange system 40 will now be described with reference to FIGS. 6 to 10.

First of all, with reference to FIGS. 6, 7 and 8, the heat exchange system 40 may be a system 40 for superheating gases at the inlet to the solid-oxide stack 20 of the SOEC/SOFC type.

It may thus be formed at least partly by at least one hollow clamping rod 55 of the clamping system 60 inside which the gases GE to be superheated circulate, the assembly 80 moreover comprising an inlet pipe 90 into the stack 20 fluidically connected to at least one hollow clamping rod 55. Advantageously, the superheating system 40 is formed by at least two hollow clamping rods 55, that is to say at least one hollow clamping rod 55 per fluid circuit.

With reference to FIG. 6, the superheating system 40 may be of the simple mounting type. Thus it comprises a simple mounting connection pipe 91 fluidically connecting the inlet pipe 90 into the stack 20 and an end 55b of a hollow clamping rod 55, the other end 55a of the hollow clamping rod 55 being fluidically connected to a pipe 99 for supplying the gas GE to be superheated.

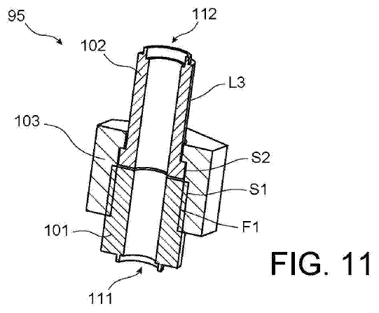

As can be seen in FIG. 6, the simple mounting connection pipe 91 may have an angled shape. In addition, the connection between the inlet pipe 90 and the simple mounting connection pipe 91, as well as between the simple mounting connection pipe 91 and the hollow clamping rod 55, and also between the hollow clamping rod 55 and the pipe 99 supplying gas GE to be superheated, can be done by means of a demountable fluidtight coupling 95, as will be described hereinafter, in particular with reference to FIG. 11.

Furthermore, the clamping rods 55 may be fixed partly to the top 45 and bottom 46 clamping plates by means of clamping means 58 in the form of clamping washers 58.

In the example in FIG. 6, the simple-mounting superheating system 40 uses only one hollow clamping rod 55 per gas, which therefore generally leads to using two hollow clamping rods, one for each fluid circuit.

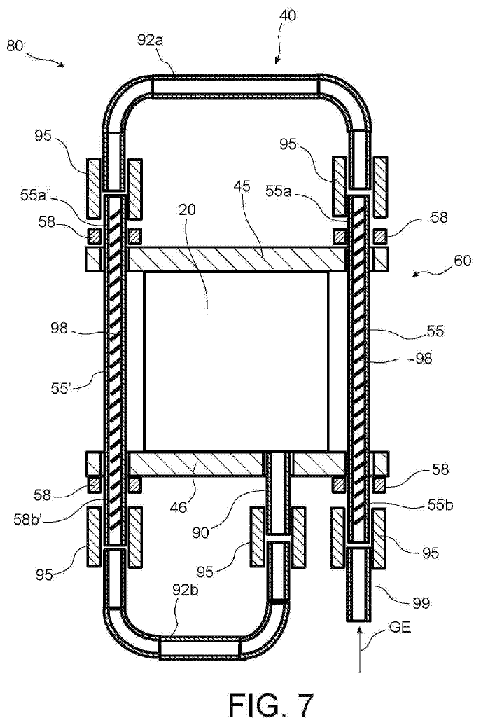

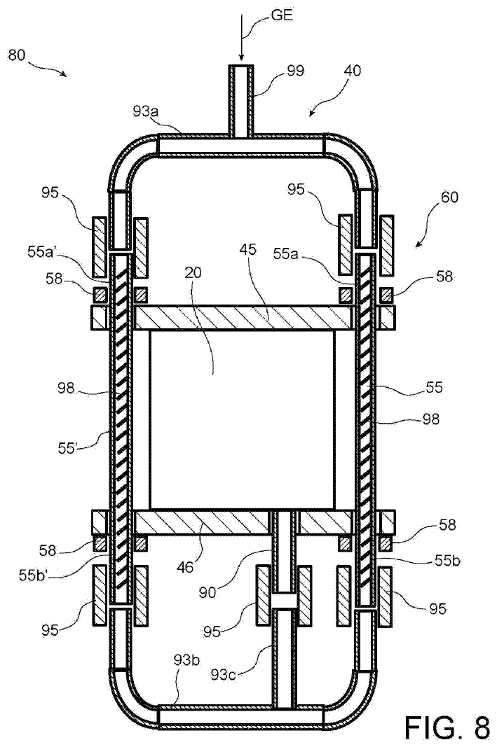

However, in order to increase the superheating of the gases, at least two hollow clamping rods 55, 55′ can be used, as described hereinafter with reference to FIGS. 7 and 8. More precisely, FIG. 7 illustrates the case of mounting in series and FIG. 8 illustrates the case of mounting in parallel.

Thus, with reference to FIG. 7, the superheating system 40 may be mounted in series. It then comprises a set of series mounting pipes 92a and 92b, which comprises a first series mounting connection 92a, fluidically connecting a first end 55a′ of a first hollow clamping rod 55′ to a first end 55a of a second hollow clamping rod 55, and a second series mounting connection pipe 92b fluidically connecting the second end 55b′ of the first clamping rod 55′ to the inlet pipe 90 into the stack 20. In addition, the second end 55b of the second hollow clamping road 55 is fluidically connected to an inlet pipe 99 for gas GE to be superheated.

As can be seen in FIG. 7, the first series mounting connection pipe 92a and the second series mounting connection pipe 92b may have an angled shape. In addition, the connection between the inlet pipe 90 and the second series mounting connection pipe 92b, and also between the second series mounting connection pipe 92b and the first hollow clamping rod 55′, and also between the first hollow clamping rod 55′ and the first series mounting connection pipe 92a, and also between the first series mounting connection pipe 92a and the second hollow clamping rod 55, and finally also between the second hollow clamping rod 55 and the pipe 99 for supplying gas GE to be superheated, can be done by means of a demountable fluidtight coupling 95, as will be described hereinafter, in particular with reference to FIG. 11.

Furthermore, the clamping rods 55 may be fixed partly to the top 45 and bottom 46 clamping plates by means of clamping means 58 in the form of clamping washers 58.

However, the use of a single hollow clamping rod 5 for simple mounting or two hollow clamping rods 55, 55′ for series mounting may have an influence on the thermics of the stack 20. This is because the passage of the gas through the clamping rods locally modifies the temperatures, which may cause a risk of temperature gradients in the plane of the stack 20. Thus it may be possible to use two hollow clamping rods 55, 55′ in parallel so as to have less influence on the thermics of the stack 20.

Thus, with reference to FIG. 8, the superheating system 40 may be of the mounting in parallel type. It comprises a set of mounting pipes in parallel 93a, 93b and 93c, which comprises a first parallel-mounting connection pipe 93a, fluidically connecting a first end 55a′ of a first hollow clamping rod 55′ to a first end 55a of a second hollow clamping rod 55, and a second parallel-mounting connection pipe 93b, fluidically connecting the second end 55b′ of the first clamping rod 55′ to the second end 55b of the second hollow clamping rod 55. In addition, the second parallel-mounting connection pipe 93b is fluidically connected to the inlet pipe 90 in the stack 20 by means of a connection pipe 93c itself fluidically connected to the inlet pipe 90 into the stack 20. Furthermore, the first parallel-mounting connection pipe 93a is fluidically connected to a pipe 99 for supplying gas GE to be superheated.

As can be seen in FIG. 8, the first parallel-mounting connection pipe 93a and the second parallel-mounting connection pipe 93b may have an angled shape. In addition, the connection between the inlet pipe 90 and the connection pipe 93c, and also between the second parallel-mounting connection pipe 93b and the first hollow clamping rod 55′??, and also between the first hollow clamping rod 55′ and the first parallel-mounting connection pipe 93a, and also between the first parallel-mounting connection pipe 93a and the second hollow clamping rod 55, and also between the second hollow clamping rod 55 and the second parallel-mounting connection pipe 93b, can be done by means of a demountable fluidtight coupling 95, as will be described hereinafter, in particular with reference to FIG. 11. The inlet pipe 99 for its part may be formed directly on the first parallel-mounting connection pipe 93a.

Each of the heat exchange systems 40 described above with reference to FIGS. 6 to 8 can make it possible to achieve heating of the gases at the inlet to the stack 20 of the SOEC/SOFC type associated with a furnace 10, as described previously with reference to FIG. 3.

Moreover, advantageously, the hollow clamping rod or rods 55 can be used to preheat a heat-transfer fluid, liquid or gaseous, intended for another function. Thereby also, the circulation of the heat-transfer fluid in the clamping rod or rods 55 can be used for cooling thereof in order to consolidate the fluidtightness.

Thus, with reference to FIG. 10, a hollow clamping rod 55 comprises an inlet end 55a for a heat-transfer fluid FE to be preheated and an outlet end 55b for the preheated heat-transfer fluid FS. The passage of the heat-transfer fluid through the hollow clamping rod 55 will cause heating of the fluid and cooling of the hollow clamping rod 55.

At each of the inlet 55a and outlet 55b ends of the clamping rod 55, the clamping system 60 comprises a force transmission tube 70, disposed around the corresponding end 55a or 55b of the clamping rod 55, and clamping means in the form of a clamping washer 58, the force transmission tube 70 being positioned between the clamping washer 58 and the corresponding clamping plate 45 or 46.

When the heat-transfer fluid is not related to the use of the stack 20, the flow rate of heat-transfer fluid can be regulated so as to maintain a constant temperature of the clamping rod 55 according to the exothermicity of the stack 20.

Moreover, the principle of the assembly 80 with its solid-oxide stack 20 of the SOEC/SOFC type makes provision for achieving clamping in the hot zone. However, the passage of a cold heat-transfer fluid through the clamping rod 55 may make it possible to reduce the temperature and thus to be able to offset the clamping out of the cold zone ZF, as illustrated in FIG. 10.

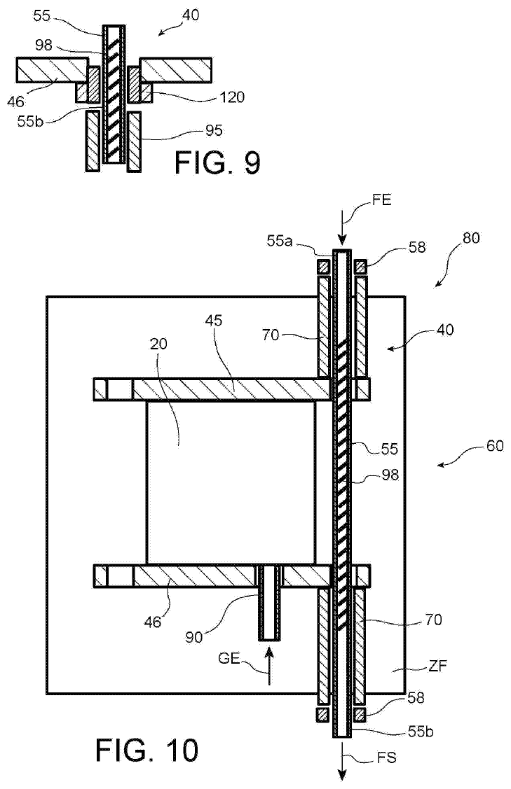

Moreover, as illustrated in FIG. 9, at each of the inlet 55a and outlet 55b ends of the clamping rod 55, the clamping system 60 may comprise a thermal insulation part 120, in particular made from ceramic, disposed around the corresponding end 55a or 55b of the clamping rod 55. This thermal insulation part 120 is positioned in contact with the corresponding clamping plate 45 or 46.

The principle of the invention is thus advantageous in enabling the preheating of a heat-transfer fluid, in particular gas. This is because, in SOEC or SOFC mode above the autothermal, the stack 20 is exothermic, it produces heat, and the heat must be discharged in order to limit the rise in temperature of the stack 20. Although some of this heat is discharged by means of thermal losses from the hot zone, the principle of the invention can make it possible to discharge a major part of this heat by preheating a heat-transfer fluid, in particular a gas, entering a hollow clamping rod 55 much colder than the operating temperature, below 200° C. typically.

This will also have the consequence of reducing the temperature of the clamping rods 55, and therefore increasing their risk of creep, and therefore also increasing the reliability of the clamping system 60. This can therefore make it possible to reduce the cross-section of the clamping rods 55. However, in the case where the heat-transfer fluid would have a tendency to cool the stack 20 excessively, the thermal insulation part 120, preferentially produced from ceramic, can be interposed between a clamping plate 45, 46 of the clamping system 60 and for example a demountable fluidtight coupling 95, as can be seen in FIG. 9.

Furthermore, as can be seen in all of FIGS. 6, 7, 8 and 10, the hollow clamping rod or rods 55 can advantageously comprise swirl means 98, for increasing the heat exchange with the fluid to be superheated or preheated.

The presence of swirl means 98 in the hollow clamping rods 55 can make it possible to increase the heat-exchange efficacy. This is because the normal length of a clamping rod 55 may prove to be insufficient to allow the superheating or preheating of a fluid, which may for example correspond to a change from 50° C. to 800° C. for gases to be superheated.

The swirl means 98 may be in the form of long twisted ribbons inserted in the hollow clamping rods 55 and have the advantage of being simple to install. They make it possible, for the same flow rate, to increase the residence time of the fluid for a given length, while limiting the increase in pressure drop, which is particularly desirable.

Moreover, FIG. 11 illustrates, partially in cross-section and in perspective, an example of a demountable fluidtight coupling 95 in the form of a coupling system fluidtight at high temperature for an assembly 80 according to the invention. This coupling 95 can make it possible to provide the fluid connections between the fluid pipes 91, 92a, 92b, 93a, 93b, 93c, 90 or 99, or between these fluid pipes 91, 92a, 92b, 93a, 93b, 93c, 90 or 99 and the hollow clamping rods 55, 55′. Such a coupling 95 is in particular described in the French patent application No. 17 50009.

Advantageously, this coupling 95 thus comprises:
a hollow base 101 at least partially threaded F1 on its external surface, referred to as a threaded base, intended to be fixed to a fluid pipe 91, 92a, 92b, 93a, 93b, 93c, 90, 99 or a hollow clamping rod 55, 55′, this threaded base 101 comprising an orifice 111 for putting in fluid communication with this fluid pipe or hollow clamping rod,
a hollow base 102 with an at least partially smooth external surface L3, referred as a smooth base, intended to be fixed to another fluid pipe 91, 92a, 92b, 93a, 93b, 93c, 90, 99 or another hollow clamping rod 55, 55′, this smooth base 102 comprising an orifice 112 for putting in fluid communication with this fluid pipe or hollow clamping rod, the smooth base 102 and the threaded base 101 each comprising an orifice 111, 112 for putting them in fluid communication with each other,
a threaded nut 103, able to cooperate with the threaded base 101 in order to form a screw/nut system and able to slide with respect to the smooth base 102, the threaded nut 103 comprising, on its internal surface, a first threaded portion 51 cooperating with the thread F1 of the threaded base 101 and a second smooth portion S2 in sliding contact on the smooth external surface L3 of the smooth base 102.

Naturally, the invention is not limited to the example embodiments that have just been described. Various modifications can be made thereto by a person skilled in the art.

What is claimed is:

1. Assembly, comprising:
a solid-oxide stack of the SOEC/SOFC type functioning at high temperature, comprising:
a plurality of electrochemical cells each formed by a cathode, an anode and an electrolyte interposed between the cathode and the anode, and a plurality of intermediate interconnectors each arranged between two adjacent electrochemical cells,
a top end plate and a bottom end plate, between which the plurality of electrochemical cells and the plurality of intermediate interconnectors are gripped,
a system for gripping the solid-oxide stack of the SOEC/SOFC type, comprising a top clamping plate and a bottom clamping plate, between which the solid-oxide stack of the SOEC/SOFC type is gripped, each clamping plate comprising at least two clamping orifices, the clamping system further comprising:
at least two clamping rods intended each to extend through a clamping orifice in the top clamping plate and through a corresponding clamping orifice in the bottom clamping plate to enable the top and bottom clamping plates to be assembled together,
clamping means at each clamping orifice of the top and bottom clamping plates intended to cooperate with said at least two clamping rods in order to enable the top and bottom clamping plates to be assembled together, comprising a heat exchange system formed at least partly by at least two hollow clamping rods of the clamping system inside which a fluid to be superheated or preheated circulates, and
wherein said at least two hollow clamping rods each comprise an inlet end for a heat-transfer fluid to be preheated and an outlet end for the preheated heat-transfer fluid, and/or wherein that the heat exchange system is a system for superheating the gases at the inlet of the solid-oxide stack of the SOEC/SOFC type, formed at least partly by at least two hollow clamping rods of the clamping system inside which the gases or liquids to be superheated circulate, the assembly comprising an inlet pipe into the stack fluidically connected to at least one hollow clamping rod.

2. Assembly according to claim 1, wherein said at least two hollow clamping rods each comprise an end for the entry of a heat-transfer fluid to be preheated and an end for exit of the preheated heat transfer fluid.

3. Assembly according to claim 2, wherein, at each of the inlet and outlet ends of each clamping rod, the clamping system comprises a force transmission tube, disposed around the corresponding end of the clamping rod, and a clamping washer, the force transmission tube being positioned between the clamping washer and the corresponding clamping plate.

4. Assembly according to claim 2, wherein, at each of the inlet and outlet ends of each clamping rod, the clamping system comprises a thermal-insulation part, disposed around the corresponding end of the clamping rod, the thermal-insulation part being positioned in contact with the corresponding clamping plate.

5. Assembly according to claim 1, wherein the heat exchange system is a system for superheating the gases at the inlet of the solid-oxide stack of the SOEC/SOFC type, formed at least partly by at least two hollow clamping rods of the clamping system inside which the gases or liquids to be superheated circulate, the assembly comprising a pipe for entering the stack fluidically connected to at least one hollow clamping rod.

6. Assembly according to claim 5, wherein the superheating system is of so-called simple mounting, comprising a simple-mounting connection pipe fluidically connecting the inlet pipe and one end of a hollow clamping rod, the other end of the hollow clamping rod being fluidically connected to a pipe for supplying gas to be superheated.

7. Assembly according to claim 5, wherein the superheating system is of so-called mounting in series, comprising a set of pipes for mounting in series, comprising a first pipe for mounting-in-series connection, fluidically connecting a first end of a first hollow clamping rod to a first end of a second hollow clamping rod, and a second pipe for mounting-in-series connection fluidically connecting the second end of the first clamping rod to the pipe for entering the stack, the second end of the second hollow clamping rod being fluidically connected to a pipe for the entry of gas to be superheated.

8. Assembly according to claim 5, wherein the superheating system is of the so-called parallel mounting type, comprising a set of parallel-mounting pipes, comprising a first parallel-mounting connection pipe fluidically connecting a first end of a first hollow clamping rod to a first end of a second hollow clamping rod, and a second parallel-mounting connection pipe fluidically connecting the second end of the first clamping rod to the second end of the second hollow clamping rod, the second parallel-mounting connection pipe being fluidically connected to the pipe for entering the stack by means of a connection pipe itself fluidically connected to the pipe for entering the stack, the first parallel-mounting connection pipe being fluidically connected to a pipe for the entry of gas to be superheated.

9. Assembly according to claim 1, wherein said at least two hollow clamping rods comprise swirl means, for increasing the heat exchange with the fluid to be superheated or preheated.

10. Assembly according to claim 5, wherein the clamping system comprises, at each end of a hollow clamping rod, a clamping washer in contact with a clamping plate.

11. Assembly according to claim 5, wherein the fluid connections between fluid pipes and/or between fluid pipes and hollow clamping rods, are produced by means of one or more demountable fluidtight couplings.

12. Method for manufacturing at least one heat exchange system (40) of an assembly according to claim 1, comprising the step consisting of forming a plurality of hollow clamping rods and fluidically connecting one or more fluid pipes with the hollow clamping rods so as to allow circulation of a fluid inside the hollow clamping rods.
